(19) United States
(12) Patent Application Publication
(10) Pub. No.: US 2018/0195023 A1
(43) Pub. Date: Jul. 12, 2018

(54) MINERAL-OIL CLEANING COMPOSITION AND METHOD FOR CLEANING ARTICLE HAVING MINERAL OIL ADHERING THERETO USING THE SAME

(71) Applicant: SUMITOMO ELECTRIC INDUSTRIES, LTD., Osaka-shi, Osaka (JP)

(72) Inventor: Keiichi IKEDA, Osaka-shi, Osaka (JP)

(73) Assignee: SUMITOMO ELECTRIC INDUSTRIES, LTD., Osaka-shi, Osaka (JP)

(21) Appl. No.: 15/744,234

(22) PCT Filed: Jun. 7, 2016
(86) PCT No.: PCT/JP2016/066815

§ 371 Date: Jan. 12, 2018

(30) Foreign Application Priority Data
Sep. 14, 2015 (JP) 2015-181261

(51) Int. Cl. C11D 1/75; C11D 1/14; C11D 3/04; C11D 3/10; C11D 3/20; C11D 11/00

(52) U.S. Cl. CPC C11D 1/75; C11D 1/14; C11D 3/042; C11D 11/0011; C11D 3/2079; C11D 3/2082; C11D 3/10

(57) ABSTRACT

A mineral-oil cleaning composition contains a compound A, serving as a surfactant, represented by formula (1) below, a compound B, serving as a surfactant, represented by formula (2) below, and water. The mineral-oil cleaning composition has a ratio of a content S1 of the compound A to a sum of the content S1 of the compound A and a content S2 of the compound B (S1/(S1+S2)) of from 0.35 to 0.85 and has a pH of more than 8.0. In formula (1) below, R¹ is an alkyl group of from 12 to 14 carbon atoms; R² and R³ are each independently a hydrogen atom or an alkyl group of from 1 to 3 carbon atoms; and an arrow between nitrogen and oxygen atoms represents a coordination bond. In formula (2), R⁴ is an alkyl group of from 12 to 14 carbon atoms.

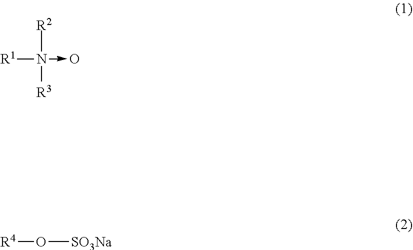

### TECHNICAL FIELD

The present invention relates to mineral-oil cleaning compositions and methods for cleaning articles having mineral oil adhering thereto using such compositions.

### BACKGROUND ART

Articles such as filtration-separation membranes that have been used for oil filtration, pipes that have been used for oil passage, and tanks that have been used for oil storage often become clogged with solidified oil. After use, such articles need to be cleaned with cleaners to remove any oil. As a cleaner composition capable of cleaning such oily soil, a cleaner composition for oily soil removal is disclosed that contains predetermined amounts of an alkylamine oxide, an inorganic alkali agent, and an organic solvent (see Japanese Patent No. 4944342).

### CITATION LIST

### Patent Literature

PTL 1: Japanese Patent No. 4944342

### SUMMARY OF INVENTION

### Technical Problem

However, the foregoing cleaner composition has insufficient detergency for high-molecular-weight oils having large numbers of carbon atoms, particularly mineral oil. Mineral oil may be difficult to remove since it contains high-molecular-weight hydrocarbon compounds having large numbers of carbon atoms.

In view of the foregoing, an object of the present invention is to provide a mineral-oil cleaning composition and a method for cleaning an article having mineral oil adhering thereto with significantly high detergency for mineral oil.

### Solution to Problem

To achieve the foregoing object, a mineral-oil cleaning composition according to one aspect of the present invention contains a compound A, serving as a surfactant, represented by formula (1) below, a compound B, serving as a surfactant, represented by formula (2) below, and water. The mineral-oil cleaning composition has a ratio of a content S1 of the compound A to a sum of the content S1 of the compound A and a content S2 of the compound B (S1/(S1+S2)) of from 0.35 to 0.85 and has a pH of more than 8.0.

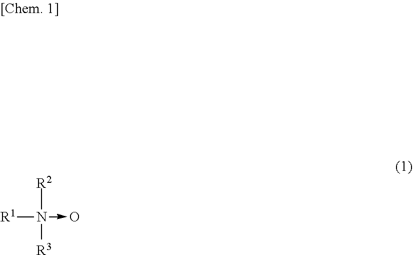

(where R¹ is an alkyl group of from 12 to 14 carbon atoms; R² and R³ are each independently a hydrogen atom or an alkyl group of from 1 to 3 carbon atoms; and an arrow between nitrogen and oxygen atoms represents a coordination bond.)

[Chem. 2]

R⁴—O—SO₃Na (2)

(where R⁴ is an alkyl group of from 12 to 14 carbon atoms.)

To achieve the foregoing object, a method for cleaning an article having mineral oil adhering thereto according to another aspect of the present invention includes a contact step of contacting an article having mineral oil adhering thereto with the mineral-oil cleaning composition described above. As used herein, the term “mineral oil” refers to an oil containing hydrocarbon compounds and derived from underground resources such as petroleum, natural gas, and coal.

### Advantageous Effects of Invention

A mineral-oil cleaning composition according to one aspect of the present invention has significantly high detergency for oils containing high-molecular-weight hydrocarbon compounds having large numbers of carbon atoms, particularly mineral oil. A method for cleaning an article having mineral oil adhering thereto according to another aspect of the present invention can be used to easily remove mineral oil from an article having mineral oil adhering thereto.

### BRIEF DESCRIPTION OF DRAWINGS

FIG. 1 is a schematic diagram of a system used in the Examples.

### DESCRIPTION OF EMBODIMENTS

### Description of Embodiments of Invention

A mineral-oil cleaning composition according to one aspect of the present invention contains a compound A, serving as a surfactant, represented by formula (1) below, a compound B, serving as a surfactant, represented by formula (2) below, and water. The mineral-oil cleaning composition has a ratio of the content S1 of the compound A to the sum of the content S1 of the compound A and the content S2 of the compound B (S1/(S1+S2)) of from 0.35 to 0.85 and has a pH of more than 8.0.

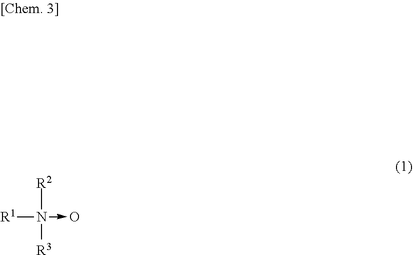

(where R¹ is an alkyl group of from 12 to 14 carbon atoms; R² and R³ are each independently a hydrogen atom or an alkyl group of from 1 to 3 carbon atoms; and an arrow between nitrogen and oxygen atoms represents a coordination bond.)

[Chem. 4]

R⁴−O—SO₃Na (2)

(where R⁴ is an alkyl group of from 12 to 14 carbon atoms.)

The compounds A and B present as surfactants in the mineral-oil cleaning composition produce improved detergency for mineral oil. Although the mechanism through which the compounds A and B present as surfactants in the mineral-oil cleaning composition produce high detergency for mineral oil is not fully understood, it is believed, for example, that the compounds A and B interact with each other to form micelle structures into which mineral oil is encapsulated.

The mineral-oil cleaning composition is preferably free of surfactants other than the compounds A and B. Surfactants other than the compounds A and B can act on the compounds A and B and decrease the cleaning effect of the compounds A and B. As described above, if the mineral-oil cleaning composition is free of surfactants other than the compounds A and B, the cleaning effect does not decrease.

The mineral-oil cleaning composition preferably further contains an alkali metal hydroxide or an alkali metal carbonate. The use of an alkali metal hydroxide or an alkali metal carbonate allows the pH of the mineral-oil cleaning composition to be easily adjusted.

The mineral-oil cleaning composition preferably further contains at least one compound selected from the group consisting of hydrochloric acid, sulfuric acid, citric acid, acetic acid, formic acid, and oxalic acid. The use of at least one compound selected from the group consisting of hydrochloric acid, sulfuric acid, citric acid, acetic acid, formic acid, and oxalic acid allows the pH of the mineral-oil cleaning composition to be easily adjusted.

The compound A is preferably dodecyldimethylamine oxide, and the compound B is preferably sodium dodecyl sulfate. The use of dodecyldimethylamine oxide as the compound A and sodium dodecyl sulfate as the compound B further improves the detergency of the mineral-oil cleaning composition.

A method for cleaning an article having mineral oil adhering thereto according to another aspect of the present invention includes a contact step of contacting an article having mineral oil adhering thereto with the mineral-oil cleaning composition described above.

According to this method for cleaning an article having mineral oil adhering thereto, the mineral-oil cleaning composition described above can be used to easily remove mineral oil, which is difficult to remove with known cleaners.

The article having mineral oil adhering thereto is preferably at least one article selected from the group consisting of filtration-separation membranes, mineral oil transport pipes, and mineral oil storage tanks. This method for cleaning an article having mineral oil adhering thereto has a high degree of cleaning effect on filtration-separation membranes, mineral oil transport pipes, and mineral oil storage tanks and can thus be used to effectively clean filtration-separation membranes, mineral oil transport pipes, mineral oil storage tanks, and combinations thereof.

### Details of Embodiments of Invention

Various embodiments of the present invention will now be described in detail.

### First Embodiment

### Mineral-Oil Cleaning Composition

A mineral-oil cleaning composition according to a first embodiment of the present invention (hereinafter also referred to as “first mineral-oil cleaning composition”) contains compounds A and B serving as surfactants and water. The mineral-oil cleaning composition has a ratio of the content S1 of the compound A to the sum of the content S1 of the compound A and the content S2 of the compound B (S1/(S1+S2)) of from 0.35 to 0.85 and has a pH of more than 8.0.

The compounds A and B present as surfactants in the first mineral-oil cleaning composition interact with each other to form micelle structures into which mineral oil is encapsulated, thus producing superior detergency for mineral oil.

### Compound A

The compound A, as described above, is a compound represented by formula (1) below.

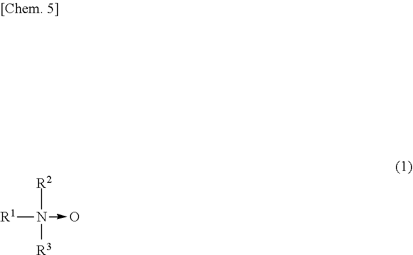

In formula (1) above, R¹ is an alkyl group of from 12 to 14 carbon atoms; R² and R³ are each independently a hydrogen atom or an alkyl group of from 1 to 3 carbon atoms; and an arrow between nitrogen and oxygen atoms represents a coordination bond.

The alkyl group of from 12 to 14 carbon atoms for R¹ above may be linear or branched. Examples of linear alkyl groups of 12 carbon atoms include dodecyl groups. Examples of branched alkyl groups of 12 carbon atoms include methylundecyl, dimethyldecyl, ethyldecyl, ethylmethylnonyl, and propylnonyl groups. Examples of linear alkyl groups of 13 carbon atoms include tridecyl groups. Examples of branched alkyl groups of 13 carbon atoms include methyldodecyl, dimethylundecyl, ethylundecyl, and ethylmethyldecyl groups. Examples of linear alkyl groups of 14 carbon atoms include tetradecyl groups. Examples of branched alkyl groups of 14 carbon atoms include methyltridecyl, dimethyldodecyl, ethyldodecyl, and ethylmethylundecyl groups. Preferred among these are dodecyl and tetradecyl groups, more preferably dodecyl groups. The selection of a dodecyl group as the alkyl group for R¹ facilitates the formation of micelle structures by the compounds A and B, thus improving the detergency of the first mineral-oil cleaning composition.

Specific examples of alkyl groups of from 1 to 3 carbon atoms for R² and R³ include methyl, ethyl, propenyl, and isopropenyl groups. More preferred among these are methyl groups. The selection of methyl groups as the alkyl groups for R² and R³ facilitates the formation of micelle structures by the compounds A and B, thus improving the detergency for mineral oil.

The arrow between the nitrogen and oxygen atoms represents a coordination bond. The coordination bond present in the compound A polarizes the compound A. This facilitates the formation of micelle structures by the polar compound A and the compound B, thus allowing the first mineral-oil cleaning composition to have significantly high detergency.

Specific preferred examples of compounds A include dodecyldimethylamine oxide, tridecyldimethylamine oxide, and tetradecyldimethylamine oxide. More preferred among these are dodecyldimethylamine oxide and tetradecyldimethylamine oxide, even more preferably dodecyldimethylamine oxide. Dodecyldimethylamine oxide has good compatibility with sodium dodecyl sulfate, sodium tridecyl sulfate, and sodium tetradecyl sulfate, which are given as specific preferred examples of compounds B. The selection of these surfactants allows the first mineral-oil cleaning composition to have significantly high detergency.

### Compound B

The compound B, as described above, is a compound represented by formula (2) below.

[Chem. 6]

R⁴—O—SO₃Na (2)

In formula (2) above, R⁴ is an alkyl group of from 12 to 14 carbon atoms.

As with the alkyl group for R′, the alkyl group for R⁴ may be linear or branched. Examples of alkyl groups for R⁴ are similar to those for R′. Preferred among these are dodecyl and tetradecyl groups, more preferably dodecyl groups. The selection of a dodecyl group as the alkyl group for R⁴ facilitates the formation of micelle structures by the compounds A and B, thus improving the detergency of the first mineral-oil cleaning composition.

Specific preferred examples of compounds B include sodium dodecyl sulfate, sodium tridecyl sulfate, and sodium tetradecyl sulfate. More preferred among these are sodium dodecyl sulfate and sodium tetradecyl sulfate, even more preferably sodium dodecyl sulfate. Sodium dodecyl sulfate has good compatibility with dodecyldimethylamine oxide, tridecyldimethylamine oxide, and tetradecyldimethylamine oxide, which are given as specific preferred examples of compounds A. The selection of these surfactants allows the first mineral-oil cleaning composition to have significantly high detergency.

The first mineral-oil cleaning composition is preferably free of surfactants other than the compounds A and B. If the first mineral-oil cleaning composition contains compounds other than the compounds A and B as surfactants, these other compounds can act on the compounds A and B and decrease the cleaning effect of the compounds A and B. However, if the first mineral-oil cleaning composition is free of surfactants other than the compounds A and B, the detergency of the first mineral-oil cleaning composition does not decrease since the cleaning action of the compounds A and B is not affected by surfactants other than the compounds A and B.

### Solvent

The first mineral-oil cleaning composition contains water as a solvent. Although the first mineral-oil cleaning composition may contain solvents other than water, such as organic solvents, it is preferred that the first mineral-oil cleaning composition contain only water as a solvent. If the first mineral-oil cleaning composition contains only water as a solvent, there is no need to use organic solvents, which have a large environmental impact, thus making the first mineral-oil cleaning composition easier to handle.

### pH Adjuster

To increase the pH of the first mineral-oil cleaning composition, the first mineral-oil cleaning composition may contain an alkali metal hydroxide or an alkali metal carbonate as a pH adjuster. In this case, the first mineral-oil cleaning composition may contain both an alkali metal hydroxide and an alkali metal carbonate as pH adjusters. The use of an alkali metal hydroxide or an alkali metal carbonate, or both, allows the pH of the first mineral-oil cleaning composition to be easily adjusted. Examples of alkali metal hydroxides include sodium hydroxide and potassium hydroxide. Preferred among these is sodium hydroxide, which is easy to handle. Examples of alkali metal carbonates include sodium carbonate and potassium carbonate. Preferred among these is sodium carbonate, which is easy to handle.

To decrease the pH of the first mineral-oil cleaning composition, the first mineral-oil cleaning composition may contain hydrochloric acid, sulfuric acid, citric acid, acetic acid, formic acid, or oxalic acid as a pH adjuster. In this case, the first mineral-oil cleaning composition may contain any combination of hydrochloric acid, sulfuric acid, citric acid, acetic acid, formic acid, and oxalic acid as pH adjusters.

### Other Ingredients

The first mineral-oil cleaning composition may contain other ingredients. Examples of such ingredients include preservatives, diluting solvents, stabilizing solvents, abrasives, colorants, and perfumes.

### Proportion of Content of Compound A to Content of Compound B

If the content of the compound A is S1 and the content of the compound B is S2, the first mineral-oil cleaning composition has a ratio of the content S1 of the compound A to the sum of the content S1 of the compound A and the content S2 of the compound B, i.e., S1/(S1+S2), within a predetermined range, which allows the first mineral-oil cleaning composition to have superior detergency for mineral oil.

The ratio is from 0.35 to 0.85. The preferred lower limit of the ratio is 0.40, more preferably 0.45, whereas the preferred upper limit of the ratio is 0.65, more preferably 0.55. If the ratio falls below the lower limit, the first mineral-oil cleaning composition has low detergency for mineral oil. Similarly, if the ratio exceeds the upper limit, the first mineral-oil cleaning composition has low detergency for mineral oil. Specifically, a ratio within the above range will facilitate the formation of micelle structures, thereby improving the detergency for mineral oil.

The preferred lower limit of the total concentration of the compounds A and B present in the first mineral-oil cleaning composition is 0.05% by mass, more preferably 0.10% by mass, even more preferably 0.20% by mass, whereas the preferred upper limit of the total concentration of the compounds A and B is 4.0% by mass, more preferably 2.0% by mass, even more preferably 1.2% by mass. As used herein, the total concentration of the compounds A and B present in the first mineral-oil cleaning composition refers to the total mass of the compounds A and B divided by the mass of the first mineral-oil cleaning composition and multiplied by 100. If the proportion of the content of the compound A to the content of the compound B and the total concentration of the compounds A and B are not lower than their respective lower limits, the cleaning effect of the first mineral-oil cleaning composition can be readily achieved. If the proportion of the content of the compound A to the content of the compound B and the total concentration of the compounds A and B are not higher than their respective upper limits, the handleability of the first mineral-oil cleaning composition can be improved.

### pH of Mineral-Oil Cleaning Composition

The first mineral-oil cleaning composition has a pH of more than 8.0. It is preferred to set the pH to a suitable level that does not cause, for example, degradation, deformation, or fracturing of an article having mineral oil adhering thereto, such as a filtration-separation membrane, a mineral oil transport pipe, or a mineral oil storage tank. If the article having mineral oil adhering thereto has high pH resistance, the preferred lower limit of the pH is 10.0, more preferably 12.5. Although any upper limit may be set on the pH, a higher pH is preferred, and the pH may be 14.0. A pH within the above range facilitates the formation of micelle structures, thereby improving the detergency of the first mineral-oil cleaning composition.

### Method for Manufacturing Mineral-Oil Cleaning Composition

The first mineral-oil cleaning composition can be manufactured by a method including a step of stirring the compounds A and B, a pH adjuster, and a solvent together.

In the stirring step, the compounds A and B, a pH adjuster, and a solvent are placed into a container for mixing and are mixed and stirred together for a predetermined period of time to prepare the first mineral-oil cleaning composition. The mixing and stirring may be performed for any period of time sufficient for the mixture to be well mixed. The preferred lower limit of the mixing and stirring time is 10 minutes, more preferably 20 minutes, even more preferably 30 minutes, whereas the preferred upper limit of the mixing and stirring time is 90 minutes, more preferably 80 minutes, even more preferably 70 minutes. A mixing and stirring time within the above range allows the mixture to be well stirred and mixed.

The preferred lower limit of the solvent temperature in the stirring step is 45° C., more preferably 50° C., even more preferably 55° C., whereas the preferred upper limit of the temperature is 80° C., more preferably 75° C., even more preferably 70° C. A solvent temperature within the above range allows the first mineral-oil cleaning composition to be well mixed.

### Method for Cleaning Article Having Mineral Oil Adhering Thereto

The method for cleaning an article having mineral oil adhering thereto includes a contact step of contacting an article having mineral oil adhering thereto with the mineral-oil cleaning composition described above.

This method for cleaning an article having mineral oil adhering thereto uses a mineral-oil cleaning composition with significantly high detergency for mineral oil and can thus be used to effectively remove mineral oil, which is difficult to clean.

The article having mineral oil adhering thereto may be any article having mineral oil adhering thereto, such as a filtration-separation membrane for filtration of mineral oil, a mineral oil transport pipe for transport of mineral oil, or a mineral oil storage tank for storage of mineral oil. The article having mineral oil adhering thereto may also be a combination of two or more of a filtration-separation membrane, a mineral oil transport pipe, and a mineral oil storage tank, mentioned above.

The temperature of the first mineral-oil cleaning composition during cleaning is preferably set to a suitable level that does not cause, for example, degradation, deformation, or fracturing of the article having mineral oil adhering thereto, such as a filtration-separation membrane, a mineral oil transport pipe, or a mineral oil storage tank. The preferred lower limit of the temperature is 20° C., more preferably 25° C., even more preferably 30° C. Although any upper limit may be set on the temperature, a higher temperature is preferred. If the article having mineral oil adhering thereto has high temperature resistance, the preferred temperature is 60° C., more preferably 55° C., even more preferably 50° C. A first mineral-oil cleaning composition temperature within the above range facilitates the encapsulation of mineral oil into micelle structures containing the compounds A and B, thereby improving the detergency of the first mineral-oil cleaning composition.

### Second Embodiment

A mineral-oil cleaning composition according to a second embodiment of the present invention (hereinafter also referred to as “second mineral-oil cleaning composition”) contains a compound A, serving as a surfactant, represented by formula (1) below, a compound B, serving as a surfactant, represented by formula (2) below, and water. The mineral-oil cleaning composition has a ratio of the content S1 of the compound A to the sum of the content S1 of the compound A and the content S2 of the compound B (S1/(S1+S2)) of from 0.08 to less than 0.35 and has a pH of from 6.0 to 9.0.

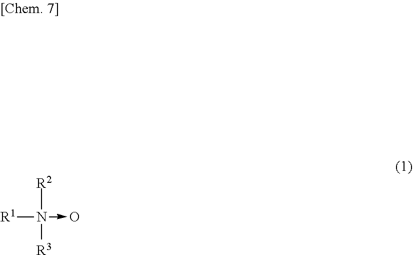

(where R¹ is an alkyl group of from 12 to 14 carbon atoms; R² and R³ are each independently a hydrogen atom or an alkyl group of from 1 to 3 carbon atoms; and an arrow between nitrogen and oxygen atoms represents a coordination bond.)

[Chem. 8]

R⁴—O—SO₃Na (2)

(where R⁴ is an alkyl group of from 12 to 14 carbon atoms.)

In the second embodiment, a description of the features other than those described above is omitted since they are identical to those of the first embodiment.

The compounds A and B present as surfactants in the second mineral-oil cleaning composition produce superior detergency for mineral oil. The second mineral-oil cleaning composition also has a ratio (S1/(S1+S2)) of from 0.08 to less than 0.35 and a pH of from 6.0 to 9.0, which allows the second mineral-oil cleaning composition to produce detergency for mineral oil.

### Third Embodiment

A mineral-oil cleaning composition according to a third embodiment of the present invention (hereinafter also referred to as “third mineral-oil cleaning composition”) contains a compound A, serving as a surfactant, represented by formula (1) below, a compound B, serving as a surfactant, represented by formula (2) below, and water. The mineral-oil cleaning composition has a ratio of the content S1 of the compound A to the sum of the content S1 of the compound A and the content S2 of the compound B (S1/(S1+S2)) of from 0.08 to 0.92 and has a pH of from 6.0 to 9.0.

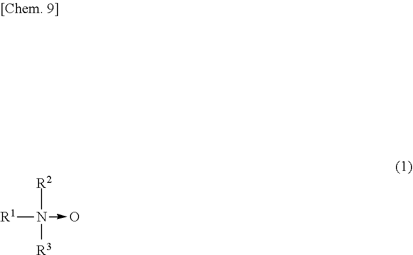

(where R¹ is an alkyl group of 10 carbon atoms; R² and R³ are each independently a hydrogen atom or an alkyl group of from 1 to 3 carbon atoms; and an arrow between nitrogen and oxygen atoms represents a coordination bond.)

[Chem. 10]

R⁴—O—SO₃Na (2)

(where R⁴ is an alkyl group of 12 carbon atoms.)

In the third embodiment, a description of the features other than those described above is omitted since they are identical to those of the first embodiment.

The compounds A and B present as surfactants in the third mineral-oil cleaning composition produce superior detergency for mineral oil. The third mineral-oil cleaning composition also has a ratio (S1/(S1+S2)) of from 0.08 to 0.92 and a pH of from 6.0 to 9.0 and has 10 carbon atoms in R′, which improves the detergency for mineral oil.

### Other Embodiments

The embodiments disclosed herein are to be considered as illustrative and not restrictive. The scope of the invention is not limited to the features of the foregoing embodiments, but is indicated by the claims, and all changes that come within the meaning and range of equivalency of the claims are intended to be embraced therein.

### EXAMPLES

The present invention is further illustrated by the following examples, although the invention is not limited to the following examples.

### Example 1

### Preparation of Mineral-Oil Cleaning Composition

Dodecyldimethylamine oxide was provided as a compound A. Sodium dodecyl sulfate was provided as a compound B. Pure water (at 60° C.) was provided as a solvent. Hydrochloric acid was provided as a pH adjuster. These were placed into a beaker and were stirred together with a magnetic stirrer for one hour to obtain 2 L (liters) of a mineral-oil cleaning composition. The mineral-oil cleaning composition had a dodecyldimethylamine oxide concentration of 0.50% by mass and a sodium dodecyl sulfate concentration of 0.50% by mass. Hence, the mineral-oil cleaning composition had a ratio of the content S1 of dodecyldimethylamine oxide to the sum of the content S1 of dodecyldimethylamine oxide and the content S2 of sodium dodecyl sulfate (S1/(S1+S2)) of 0.50. The mineral-oil cleaning composition also had a pH of 8.2.

### Example 2

A mineral-oil cleaning composition was prepared as in Example 1 except that the mineral-oil cleaning composition had a pH of 9.5 and sodium hydroxide was used as the pH adjuster.

### Example 3

A mineral-oil cleaning composition was prepared as in Example 2 except that the mineral-oil cleaning composition had a pH of 13.0.

### Example 4

A mineral-oil cleaning composition was prepared as in Example 2 except that the mineral-oil cleaning composition had a dodecyldimethylamine oxide concentration of 0.40% by mass and a sodium dodecyl sulfate concentration of 0.60% by mass. This mineral-oil cleaning composition had a ratio (S1/(S1+S2)) of 0.40.

### Example 5

A mineral-oil cleaning composition was prepared as in Example 2 except that the mineral-oil cleaning composition had a dodecyldimethylamine oxide concentration of 0.80% by mass and a sodium dodecyl sulfate concentration of 0.20% by mass. This mineral-oil cleaning composition had a ratio (S1/(S1+S2)) of 0.80.

### Example 6

A mineral-oil cleaning composition was prepared as in Example 2 except that sodium tetradecyl sulfate was used as the compound B.

### Example 7

A mineral-oil cleaning composition was prepared as in Example 2 except that tetradecyldimethylamine oxide was used as the compound A.

### Example 8

A mineral-oil cleaning composition was prepared as in Example 2 except that tetradecyldimethylamine oxide was used as the compound A and sodium tetradecyl sulfate was used as the compound B.

### Comparative Example 1

A mineral-oil cleaning composition was prepared as in Example 1 except that the mineral-oil cleaning composition had a pH of 7.0.

### Comparative Example 2

A mineral-oil cleaning composition was prepared as in Example 2 except that the mineral-oil cleaning composition had a dodecyldimethylamine oxide concentration of 0.30% by mass and a sodium dodecyl sulfate concentration of 0.70% by mass. This mineral-oil cleaning composition had a ratio (S1/(S1+S2)) of 0.30.

### Comparative Example 3

A mineral-oil cleaning composition was prepared as in Example 2 except that the mineral-oil cleaning composition had a dodecyldimethylamine oxide concentration of 0.90% by mass and a sodium dodecyl sulfate concentration of 0.10% by mass. This mineral-oil cleaning composition had a ratio (S1/(S1+S2)) of 0.90.

### Comparative Example 4

A mineral-oil cleaning composition was prepared as in Example 2 except that sodium decyl sulfate was used as the compound B.

### Comparative Example 5

A mineral-oil cleaning composition was prepared as in Example 2 except that tetradecyldimethylamine oxide was used as the compound A and sodium decyl sulfate was used as the compound B.

### Comparative Example 6

A mineral-oil cleaning composition was prepared as in Example 2 except that decyldimethylamine oxide was used as the compound A.

### Comparative Example 7

A mineral-oil cleaning composition was prepared as in Example 2 except that hexadecyldimethylamine oxide was used as the compound A.

### Comparative Example 8

A mineral-oil cleaning composition was prepared as in Example 2 except that decyldimethylamine oxide was used as the compound A and sodium tetradecyl sulfate was used as the compound B.

### Comparative Example 9

A mineral-oil cleaning composition was prepared as in Example 2 except that hexadecyldimethylamine oxide was used as the compound A and sodium tetradecyl sulfate was used as the compound B.

### Comparative Example 10

A mineral-oil cleaning composition was prepared as in Example 2 except that decyldimethylamine oxide was used as the compound A and sodium hexadecyl sulfate was used as the compound B.

### Comparative Example 11

A mineral-oil cleaning composition was prepared as in Example 2 except that sodium hexadecyl sulfate was used as the compound B.

### Comparative Example 12

A mineral-oil cleaning composition was prepared as in Example 2 except that tetradecyldimethylamine oxide was used as the compound A and sodium hexadecyl sulfate was used as the compound B.

### Comparative Example 13

A mineral-oil cleaning composition was prepared as in Example 1 except that the mineral-oil cleaning composition had a pH of 6.5, a dodecyldimethylamine oxide concentration of 0.05% by mass, and a sodium dodecyl sulfate concentration of 0.95% by mass. This mineral-oil cleaning composition had a ratio (S1/(S1+S2)) of 0.05.

### Comparative Example 14

A mineral-oil cleaning composition was prepared as in Comparative Example 13 except that the mineral-oil cleaning composition had a dodecyldimethylamine oxide concentration of 0.40% by mass and a sodium dodecyl sulfate concentration of 0.60% by mass. This mineral-oil cleaning composition had a ratio (S1/(S1+S2)) of 0.40.

### Comparative Example 15

A mineral-oil cleaning composition was prepared as in Comparative Example 13 except that the mineral-oil cleaning composition had a pH of 7.0. This mineral-oil cleaning composition had a ratio (S1/(S1+S2)) of 0.05.

### Comparative Example 16

A mineral-oil cleaning composition was prepared as in Comparative Example 15 except that the mineral-oil cleaning composition had a dodecyldimethylamine oxide concentration of 0.40% by mass and a sodium dodecyl sulfate concentration of 0.60% by mass. This mineral-oil cleaning composition had a ratio (S1/(S1+S2)) of 0.40.

### Comparative Example 17

A mineral-oil cleaning composition was prepared as in Comparative Example 13 except that the mineral-oil cleaning composition had a pH of 8.5. This mineral-oil cleaning composition had a ratio (S1/(S1+S2)) of 0.05.

### Comparative Example 18

A mineral-oil cleaning composition was prepared as in Comparative Example 3 except that the mineral-oil cleaning composition had a dodecyldimethylamine oxide concentration of 0.15% by mass and a sodium dodecyl sulfate concentration of 0.85% by mass. This mineral-oil cleaning composition had a ratio (S1/(S1+S2)) of 0.15.

Fouling of Membrane with Mineral Oil

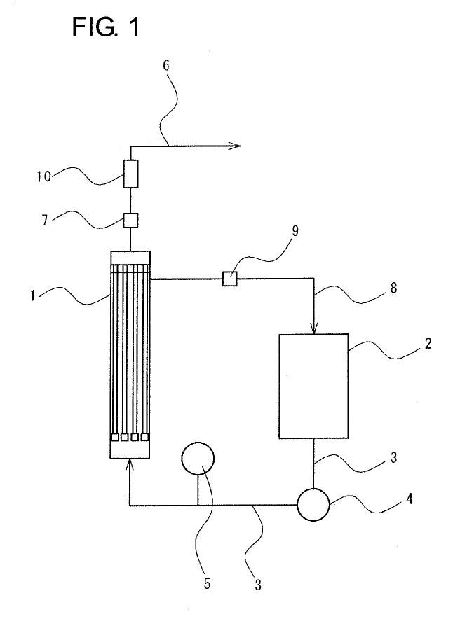

As shown in FIG. 1, 5 L of a 50 mg/L C heavy oil emulsion was filtered through a polytetrafluoroethylene (hereinafter also referred to as “PTFE”) hollow-fiber membrane module 1 under a filtration pressure of 200 kPa to allow the C heavy oil to adhere to the membrane surface of the hollow-fiber membrane module 1. As used herein, the term “C heavy oil” refers to a heavy oil containing 90% by mass or more residual oil.

Specifically, the lower end of a container 2 filled with the C heavy oil emulsion is connected to the lower end of the hollow-fiber membrane module 1 with a first tube 3. The first tube 3 was equipped with a pump 4 and a pressure gauge 5. A second tube 6 for drainage was connected to the upper end of the hollow-fiber membrane module 1. The second tube 6 was equipped with a first cock 7 capable of being opened and closed. The portion of the hollow-fiber membrane module 1 near the upper end thereof was connected to the upper end of the container 2 with a third tube 8. The third tube 8 was equipped with a second cock 9 capable of being opened and closed. In the step of fouling the membranes of the hollow-fiber membrane module 1 with mineral oil, the first cock 7 was opened, and the second cock 9 was closed. The hollow-fiber membrane module 1 had a membrane area of 0.1 m² and a nominal membrane pore size of 0.1 μm.

Cleaning of Membrane with Mineral-Oil Cleaning Compositions

As shown in FIG. 1, the membranes of the hollow-fiber membrane module 1 fouled as described above were cleaned with the mineral-oil cleaning compositions of Examples 1 to 8 and Comparative Examples 1 to 18. To clean the membranes of the hollow-fiber membrane module 1 with each mineral-oil cleaning composition, the container 2 was first filled with the mineral-oil cleaning composition. The first cock 7 was closed, and the second cock 9 was opened. The mineral-oil cleaning composition was circulated over the outer surfaces of the membranes of the hollow-fiber membrane module 1 fouled as described above for five hours to clean the membranes of the hollow-fiber membrane module 1. The circulation flow rate was set to 0.2 L/min.

Recovery Rate after Cleaning with Mineral-Oil Cleaning Compositions

The recovery rate after cleaning with each mineral-oil cleaning composition was then calculated. The pure water permeability A of the membranes before the start of the filtration of the C heavy oil emulsion and the pure water permeability B of the membranes after the cleaning of adhering mineral oil with the mineral-oil cleaning composition were determined and were used to calculate the recovery rate after cleaning (%) by the mathematical expression 100×B/A. As shown in FIG. 1, the container 2 was filled with pure water, and the second tube 6 for drainage was equipped with a flowmeter 10. In the step of determining the pure water permeability, the first cock 7 was opened, and the second cock 9 was closed. The pure water was passed through the hollow-fiber membrane module 1 before the start of the filtration of the C heavy oil emulsion and after the cleaning of adhering mineral oil with the mineral-oil cleaning composition at a pressure of 50 kPa and a temperature of 25° C. The pure water permeability of the hollow-fiber membrane module 1 was determined by measuring the flow rate of the effluent from the second tube 6 for drainage with the flowmeter 10.

Results of Cleaning with Mineral-Oil Cleaning Compositions

Table 1 shows the pH, the types and concentrations (% by mass) of the compounds A and B, the ratio (S1/(S1+S2)), the recovery rate after cleaning (%), and the cleaning effect for each mineral-oil cleaning composition. In Table 1, the “type” column for the compound A lists the substance symbols for identification of the compound A and the numbers of carbon atoms in the functional groups R¹, R², and R³ present in the compound A, and the “type” column for the compound B lists the substance symbols for identification of the compound B and the number of carbon atoms in the functional group R⁴ present in the compound B. The substance symbols listed in the “substance symbol” column for the compound A denote the following substances: A-1 is decyldimethylamine oxide, A-2 is dodecyldimethylamine oxide, A-3 is tetradecyldimethylamine oxide, and A-4 is hexadecylamine oxide. The substance symbols listed in the “substance symbol” column for the compound B denote the following substances: B-1 is sodium decyl sulfate, B-2 is sodium dodecyl sulfate, B-3 is sodium tetradecyl sulfate, and B-4 is sodium hexadecyl sulfate. In Table 1, A indicates a significantly high degree of cleaning effect, B indicates a high degree of cleaning effect, C indicates a low degree of cleaning effect, and D indicates a significantly low degree of cleaning effect.

TABLE 1

| | | Compound A | | | | | | | | | | | |
|---|---|---|---|---|---|---|---|---|---|---|---|---|---|
| | | Type | | | | | | | | | | | |
| | | | Number | | | | Compound B | | | | | | |
| | | | of | | | | Type | | | Total | | Re- | |
| | | | carbon | | | | | Number | | concentration | | covery | |
| | | | atoms in | | | | | of | | of | | rate | |
| | | | each | | | | | carbon | | compounds | | after | Clean- |
| | | Substance | group | | | Concentration | Substance | atoms | Concentration | A and B | | cleaning | ing |
| | pH | symbol | R¹ | R² | R³ | (% by mass) | symbol | in R⁴ | (% by mass) | (% by mass) | Ratio | (%) | effect |
| Ex. 1 | 8.2 | A-2 | 12 | 1 | 1 | 0.50 | B-2 | 12 | 0.50 | 1.0 | 0.50 | 83 | B |
| Ex. 2 | 9.5 | A-2 | 12 | 1 | 1 | 0.50 | B-2 | 12 | 0.50 | 1.0 | 0.50 | 85 | B |
| Ex. 3 | 13.0 | A-2 | 12 | 1 | 1 | 0.50 | B-2 | 12 | 0.50 | 1.0 | 0.50 | 92 | A |
| Ex. 4 | 9.5 | A-2 | 12 | 1 | 1 | 0.40 | B-2 | 12 | 0.60 | 1.0 | 0.40 | 84 | B |
| Ex. 5 | 9.5 | A-2 | 12 | 1 | 1 | 0.80 | B-2 | 12 | 0.20 | 1.0 | 0.80 | 85 | B |
| Ex. 6 | 9.5 | A-2 | 12 | 1 | 1 | 0.50 | B-3 | 14 | 0.50 | 1.0 | 0.50 | 84 | B |
| Ex. 7 | 9.5 | A-3 | 14 | 1 | 1 | 0.50 | B-2 | 12 | 0.50 | 1.0 | 0.50 | 84 | B |
| Ex. 8 | 9.5 | A-3 | 14 | 1 | 1 | 0.50 | B-3 | 14 | 0.50 | 1.0 | 0.50 | 83 | B |

TABLE 2

| | | Compound A | | | | | | | | | | | |
|---|---|---|---|---|---|---|---|---|---|---|---|---|---|
| | | Type | | | | | | | | | | | |
| | | | Number | | | | Compound B | | | | | | |
| | | | of | | | | Type | | | Total | | | |
| | | | carbon | | | | | Number | | concentration | | Recovery | |
| | | | atoms in | | | | | of | | of | | rate | |
| | | | each | | | | | carbon | | compounds | | after | |
| | | Substance | group | | | Concentration | Substance | atoms | Concentration | A and B | | cleaning | Cleaning |
| | pH | symbol | R¹ | R² | R³ | (% by mass) | symbol | in R⁴ | (% by mass) | (% by mass) | Ratio | (%) | effect |
| Com. Ex. 1 | 7.0 | A-2 | 12 | 1 | 1 | 0.50 | B-2 | 12 | 0.50 | 1.0 | 0.50 | 66 | C |
| Com. Ex. 2 | 9.5 | A-2 | 12 | 1 | 1 | 0.30 | B-2 | 12 | 0.70 | 1.0 | 0.30 | 55 | D |
| Com. Ex. 3 | 9.5 | A-2 | 12 | 1 | 1 | 0.90 | B-2 | 12 | 0.10 | 1.0 | 0.90 | 65 | C |
| Com. Ex. 4 | 9.5 | A-2 | 12 | 1 | 1 | 0.50 | B-1 | 10 | 0.50 | 1.0 | 0.50 | 53 | D |
| Com. Ex. 5 | 9.5 | A-3 | 14 | 1 | 1 | 0.50 | B-1 | 10 | 0.50 | 1.0 | 0.50 | 53 | D |
| Com. Ex. 6 | 9.5 | A-1 | 10 | 1 | 1 | 0.50 | B-2 | 12 | 0.50 | 1.0 | 0.50 | 51 | D |
| Com. Ex. 7 | 9.5 | A-4 | 16 | 1 | 1 | 0.50 | B-2 | 12 | 0.50 | 1.0 | 0.50 | 50 | D |
| Com. Ex. 8 | 9.5 | A-1 | 10 | 1 | 1 | 0.50 | B-3 | 14 | 0.50 | 1.0 | 0.50 | 52 | D |
| Com. Ex. 9 | 9.5 | A-4 | 16 | 1 | 1 | 0.50 | B-3 | 14 | 0.50 | 1.0 | 0.50 | 49 | D |
| Com. Ex. 10 | 9.5 | A-1 | 10 | 1 | 1 | 0.50 | B-4 | 16 | 0.50 | 1.0 | 0.50 | 48 | D |
| Com. Ex. 11 | 9.5 | A-2 | 12 | 1 | 1 | 0.50 | B-4 | 16 | 0.50 | 1.0 | 0.50 | 49 | D |
| Com. Ex. 12 | 9.5 | A-3 | 14 | 1 | 1 | 0.50 | B-4 | 16 | 0.50 | 1.0 | 0.50 | 48 | D |
| Com. Ex. 13 | 6.5 | A-2 | 12 | 1 | 1 | 0.05 | B-2 | 12 | 0.95 | 1.0 | 0.05 | 45 | D |
| Com. Ex. 14 | 6.5 | A-2 | 12 | 1 | 1 | 0.40 | B-2 | 12 | 0.60 | 1.0 | 0.40 | 50 | D |
| Com. Ex. 15 | 7.0 | A-2 | 12 | 1 | 1 | 0.05 | B-2 | 12 | 0.95 | 1.0 | 0.05 | 65 | C |
| Com. Ex. 16 | 7.0 | A-2 | 12 | 1 | 1 | 0.40 | B-2 | 12 | 0.60 | 1.0 | 0.40 | 65 | C |
| Com. Ex. 17 | 8.5 | A-2 | 12 | 1 | 1 | 0.05 | B-2 | 12 | 0.95 | 1.0 | 0.05 | 51 | D |
| Com. Ex. 18 | 9.5 | A-2 | 12 | 1 | 1 | 0.15 | B-2 | 12 | 0.85 | 1.0 | 0.15 | 49 | D |

Evaluation of Cleaning with Mineral-Oil Cleaning Compositions

### Difference in Cleaning Effect due to Difference in pH

In Examples 1, 2, and 3 and Comparative Example 1, the compound A was A-2 (where R¹ has 12 carbon atoms, R² has 1 carbon atom, and R³ has 1 carbon atom), the concentration of the compound A was 0.50% by mass, the compound B was B-2 (where R⁴ has 12 carbon atoms), the concentration of the compound B was 0.50% by mass, and the ratio (S1/(S1+S2)) was 0.50. These conditions were identical, and only the pH of each mineral-oil cleaning composition varied. The pH in Example 1 was 8.2. The pH in Example 2 was 9.5. The pH in Example 3 was 13.0. The pH in Comparative Example 1 was 7.0. As shown in Table 1, the mineral-oil cleaning compositions of Examples 1, 2, and 3, where the pH was more than 8.0, had high degrees of cleaning effect (rated A or B). In contrast, the mineral-oil cleaning composition of Comparative Example 1, where the pH was 7.0, had a low degree of cleaning effect (rated C). The above results demonstrate that a mineral-oil cleaning composition having a pH of more than 8.0 has a high degree of cleaning effect.

### Difference in Cleaning Effect due to Difference in Number of Carbon Atoms

In Examples 2 and 7 and Comparative Examples 6 and 7, the pH was 9.5, the concentration of the compound A was 0.50% by mass, the compound B was B-2 (where R⁴ has 12 carbon atoms), the concentration of the compound B was 0.50% by mass, and the ratio (S1/(S1+S2)) was 0.50. These conditions were identical, and only the type of compound A varied. The compound A in Example 2 was A-2 (where R¹ has 12 carbon atoms, R² has 1 carbon atom, and R³ has 1 carbon atom). The compound A in Example 7 was A-3 (where R¹ has 14 carbon atoms, R² has 1 carbon atom, and R³ has 1 carbon atom). The compound A in Comparative Example 6 was A-1 (where R¹ has 10 carbon atoms, R² has 1 carbon atom, and R³ has 1 carbon atom). The compound A in Comparative Example 7 was A-4 (where R¹ has 16 carbon atoms, R² has 1 carbon atom, and R³ has 1 carbon atom). As shown in Table 1, the mineral-oil cleaning composition of Example 2, where the compound A was A-2, and the mineral-oil cleaning composition of Example 7, where the compound A was A-3, had high degrees of cleaning effect (rated B). In contrast, the mineral-oil cleaning composition of Comparative Example 6, where the compound A was A-1, and the mineral-oil cleaning composition of Comparative Example 7, where the compound A was A-4, had significantly low degrees of cleaning effect (rated D).

In Examples 6 and 8 and Comparative Examples 8 and 9, the pH was 9.5, the concentration of the compound A was 0.50% by mass, the compound B was B-3 (where R⁴ has 14 carbon atoms), the concentration of the compound B was 0.50% by mass, and the ratio (S1/(S1+S2)) was 0.50. These conditions were identical, and as in the above evaluation, only the type of compound A varied. The compound A in Example 6 was A-2 (where R¹ has 12 carbon atoms, R² has 1 carbon atom, and R³ has 1 carbon atom). The compound A in Example 8 was A-3 (where R¹ has 14 carbon atoms, R² has 1 carbon atom, and R³ has 1 carbon atom). The compound A in Comparative Example 8 was A-1 (where R¹ has 10 carbon atoms, R² has 1 carbon atom, and R³ has 1 carbon atom). The compound A in Comparative Example 9 was A-4 (where R¹ has 16 carbon atoms, R² has 1 carbon atom, and R³ has 1 carbon atom). As shown in Table 1, the mineral-oil cleaning composition of Example 6, where the compound A was A-2, and the mineral-oil cleaning composition of Example 8, where the compound A was A-3, had high degrees of cleaning effect (rated B). In contrast, the mineral-oil cleaning composition of Comparative Example 8, where the compound A was A-1, and the mineral-oil cleaning composition of Comparative Example 9, where the compound A was A-4, had significantly low degrees of cleaning effect (rated D).

The above results demonstrate that the selection of a compound where R¹ has from 12 to 14 carbon atoms as the compound A improves the cleaning effect of a mineral-oil cleaning composition.

In Examples 2 and 6 and Comparative Examples 4 and 11, the pH was 9.5, the type of compound A was A-2 (where R¹ has 12 carbon atoms, R² has 1 carbon atom, and R³ has 1 carbon atom), the concentration of the compound A was 0.50% by mass, the concentration of the compound B was 0.50% by mass, and the ratio (S1/(S1+S2)) was 0.50. These conditions were identical, and only the type of compound B varied. The compound B in Example 2 was B-2 (where R⁴ has 12 carbon atoms). The compound B in Example 6 was B-3 (where R⁴ has 14 carbon atoms). The compound B in Comparative Example 4 was B-1 (where R⁴ has 10 carbon atoms). The compound B in Comparative Example 11 was B-4 (where R⁴ has 16 carbon atoms). As shown in Table 1, the mineral-oil cleaning composition of Example 2, where the compound B was B-2, and the mineral-oil cleaning composition of Example 6, where the compound B was B-3, had high degrees of cleaning effect (rated B). In contrast, the mineral-oil cleaning composition of Comparative Example 4, where the compound B was B-1, and the mineral-oil cleaning composition of Comparative Example 11, where the compound B was B-4, had significantly low degrees of cleaning effect (rated D).

In Examples 7 and 8 and Comparative Examples 5 and 12, the pH was 9.5, the compound A was A-3 (where R¹ has 14 carbon atoms, R² has 1 carbon atom, and R³ has 1 carbon atom), the concentration of the compound A was 0.50% by mass, the concentration of the compound B was 0.50% by mass, and the ratio (S1/(S1+S2)) was 0.50. These conditions were identical, and only the type of compound B varied. The compound B in Example 7 was B-2 (where R⁴ has 12 carbon atoms). The compound B in Example 8 was B-3 (where R⁴ has 14 carbon atoms). The compound B in Comparative Example 5 was B-1 (where R⁴ has 10 carbon atoms). The compound B in Comparative Example 12 was B-4 (where R⁴ has 16 carbon atoms). As shown in Table 1, the mineral-oil cleaning composition of Example 7, where the compound B was B-2, and the mineral-oil cleaning composition of Example 8, where the compound B was B-3, had significantly high degrees of cleaning effect (rated B). In contrast, the mineral-oil cleaning composition of Comparative Example 5, where the compound B was B-1, and the mineral-oil cleaning composition of Comparative Example 12, where the compound B was B-4, had significantly low degrees of cleaning effect (rated D).

The above results demonstrate that the selection of a compound where R⁴ has from 12 to 14 carbon atoms as the compound B improves the cleaning effect of a mineral-oil cleaning composition.

### Difference in Cleaning Effect due to Difference in Blend Ratio of Compound A to Compound B

In Examples 2, 4, and 5 and Comparative Examples 2, 3, and 18, the pH was 9.5, the compound A was A-2 (where R¹ has 12 carbon atoms, R² has 1 carbon atom, and R³ has 1 carbon atom), and the compound B was B-2 (where R⁴ has 12 carbon atoms). These conditions were identical, and the ratio (S1/(S1+S2)) varied. The ratio in Example 2 was 0.50. The ratio in Example 4 was 0.40. The ratio in Example 5 was 0.80. The ratio in Comparative Example 2 was 0.30. The ratio in Comparative Example 3 was 0.90. The ratio in Comparative Example 18 was 0.15. The mineral-oil cleaning composition of Example 2, where the ratio was 0.50, the mineral-oil cleaning composition of Example 4, where the ratio was 0.40, and the mineral-oil cleaning composition of Example 5, where the ratio was 0.80, had high degrees of cleaning effect (rated B). In contrast, the mineral-oil cleaning composition of Comparative Example 2, where the ratio was 0.30, and the mineral-oil cleaning composition of Comparative Example 18, where the ratio was 0.15, had significantly low degrees of cleaning effect (rated D), and the mineral-oil cleaning composition of Comparative Example 3, where the ratio was 0.90, had a low degree of cleaning effect (rated C).

The above results demonstrate that a ratio of from 0.35 to 0.85 improves the cleaning effect of a mineral-oil cleaning composition.

### INDUSTRIAL APPLICABILITY

As described above, a mineral-oil cleaning composition according to one aspect of the present invention has superior detergency for mineral oil. The mineral-oil cleaning composition is thus suitable for the cleaning of mineral oil.

### REFERENCE SIGNS LIST

1 hollow-fiber membrane module
2 container
3 first tube
4 pump
5 pressure gauge
6 second tube
7 first cock
8 third tube
9 second cock
10 flowmeter

1. A mineral-oil cleaning composition comprising:
a compound A, serving as a surfactant, represented by formula (1): 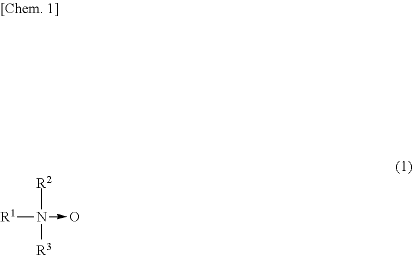
(wherein R¹ is an alkyl group of from 12 to 14 carbon atoms; R² and R³ are each independently a hydrogen atom or an alkyl group of from 1 to 3 carbon atoms; and an arrow between nitrogen and oxygen atoms represents a coordination bond);
a compound B, serving as a surfactant, represented by formula (2):
[Chem. 2]
R⁴—O—SO₃Na (2)
(wherein R⁴ is an alkyl group of from 12 to 14 carbon atoms); and
water,
the mineral-oil cleaning composition having a ratio of a content S1 of the compound A to a sum of the content S1 of the compound A and a content S2 of the compound B (S1/(S1+S2)) of from 0.35 to 0.85,
the mineral-oil cleaning composition having a pH of more than 8.0.

2. The mineral-oil cleaning composition according to claim 1, wherein the mineral-oil cleaning composition is free of surfactants other than the compounds A and B.

3. The mineral-oil cleaning composition according to claim 1, further comprising an alkali metal hydroxide or an alkali metal carbonate.

4. The mineral-oil cleaning composition according to claim 1, further comprising at least one compound selected from the group consisting of hydrochloric acid, sulfuric acid, citric acid, acetic acid, formic acid, and oxalic acid.

5. The mineral-oil cleaning composition according to claim 1, wherein the compound A is dodecyldimethylamine oxide, and the compound B is sodium dodecyl sulfate.

6. A method for cleaning an article having mineral oil adhering thereto, the method comprising a contact step of contacting an article having mineral oil adhering thereto with the mineral-oil cleaning composition according to claim 1.

7. The method for cleaning an article having mineral oil adhering thereto according to claim 6, wherein the article having mineral oil adhering thereto is at least one article selected from the group consisting of filtration-separation membranes, mineral oil transport pipes, and mineral oil storage tanks.
